(19) United States
(12) Patent Application Publication
(10) Pub. No.: US 2021/0135194 A1
(43) Pub. Date: May 6, 2021

(54) METHOD FOR MAKING SILICON-CARBON COMPOSITE ELECTRODE MATERIALS

(71) Applicant: GM GLOBAL TECHNOLOGY OPERATIONS LLC, Detroit, MI (US)

(72) Inventors: Lei WANG, Rochester Hills, MI (US); Gongshin QI, Troy, MI (US); Wei LI, Troy, MI (US)

(73) Assignee: GM GLOBAL TECHNOLOGY OPERATIONS LLC, Detroit, MI (US)

(21) Appl. No.: 16/668,864

(22) Filed: Oct. 30, 2019

(51) Int. Cl. H01M 4/36; H01M 10/0525; H01M 4/62; H01M 4/38; H01M 4/587

(52) U.S. Cl. CPC H01M 4/364; H01M 10/0525; H01M 4/587; H01M 4/366; H01M 4/386; H01M 4/625

(57) ABSTRACT

The present disclosure provides a method of forming an electrode material for use in an electrochemical cell that cycles lithium ions. The method includes contacting a catalyst precursor with one or more electroactive materials to form a mixture. The catalyst precursor includes one or more metal salts. The method may also include activating the catalyst precursor in the mixture to form an activated mixture including an activated catalyst; and/or contacting one or more carbonaceous materials with the activated mixture to form the electrode material. The electrode material includes one or more electroactive particles that may be carbon coated disposed within a carbonaceous structure.

### INTRODUCTION

This section provides background information related to the present disclosure which is not necessarily prior art.

The present disclosure relates to silicon-carbon composite electrode materials that may be used in, for example, negative electrodes of lithium-ion electrochemical cells and devices, and methods of formation relating thereto.

By way of background, high-energy density, electrochemical cells, such as lithium-ion batteries can be used in a variety of consumer products and vehicles, such as Hybrid Electric Vehicles (HEVs) and Electric Vehicles (EVs). Typical lithium ion and lithium sulfur batteries comprise a first electrode (e.g., a cathode), a second electrode (e.g., an anode), an electrolyte material, and a separator. Often a stack of battery cells is electrically connected to increase overall output. Conventional lithium-ion batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery.

Contact of the anode and cathode materials with the electrolyte can create an electrical potential between the electrodes. When electron current is generated in an external circuit between the electrodes, the potential is sustained by electrochemical reactions within the cells of the battery. Each of the negative and positive electrodes within a stack is connected to a current collector (typically a metal, such as copper for the anode and aluminum for the cathode). During battery usage, the current collectors associated with the two electrodes are connected by an external circuit that allows current generated by electrons to pass between the electrodes to compensate for transport of lithium ions.

Typical electrochemically active materials for forming an anode include lithium-graphite intercalation compounds, lithium-silicon alloying compounds, lithium-tin alloying compounds, and/or lithium alloys. While graphite compounds are most common, recently, anode materials with high specific capacity (in comparison with conventional graphite) are of growing interest. For example, silicon has the highest known theoretical charge capacity for lithium, making it one of the most promising materials for rechargeable lithium-ion batteries. However, current anode materials comprising silicon suffer from significant drawbacks.

For example, excessive volumetric expansion and contraction during successive charging and discharging cycles is observed for silicon electroactive materials. Such volumetric changes can lead to fatigue cracking and decrepitation of the electroactive material. This may lead to a loss of electrical contact between the silicon-containing electroactive material and the rest of the battery cell, resulting in a decline of electrochemical cyclic performance, diminished Coulombic charge capacity retention (capacity fade), and limited cycle life. This is especially true at electrode loading levels required for the application of silicon containing electrodes in high-energy lithium-ion batteries, such as those used in transportation applications.

Accordingly, it would be desirable to develop materials and methods that use silicon or other electroactive materials that undergo significant volumetric changes during lithium ion cycling that are capable of minimal capacity fade and maximized charge capacity in commercial lithium-ion batteries with long lifespans, especially for transportation applications.

### SUMMARY

This section provides a general summary of the disclosure, and is not a comprehensive disclosure of its full scope or all of its features.

In various aspects, the present disclosure provides a method of forming an electrode material for use in an electrochemical cell that cycles lithium ions. The method includes contacting a catalyst precursor with one or more electroactive materials to form a mixture. The catalyst precursor includes one or more metal salts. The method further includes activating the catalyst precursor in the mixture to form an activated mixture including an activated catalyst; and contacting one or more carbonaceous materials with the activated mixture to form the electrode material. The electrode material includes one or more electroactive particles disposed within a carbonaceous structure.

In one aspect, the one or more metal salts include one or more metal nitrates M(NO₃)ₓ, metal chlorates MClₓ, metal acetates M(Ac)ₓ, and metal sulfates M₂(SO₄)ₓ, where 1≤x≤5 and M is selected from the group consisting of: nickel (Ni), cobalt (Co), manganese (Mn), iron (Fe), zinc (Zn), vanadium (V), chromium (Cr), molybdenum (Mo), copper (Cu), magnesium (Mg), strontium (Sr), barium (Ba), lanthanum (La), cerium (Ce), and combinations thereof.

In one aspect, activating may include heating the mixture to a temperature greater than or equal to about 200° C. to less than or equal to about 600° C. for a time greater than or equal to about 5 minutes to less than or equal to about 2 hours.

In one aspect, the mixture may be heated in an environment including greater than about 0% to less than or equal to about 20% of hydrogen (H₂).

In one aspect, the mixture may be heated in an environment including one or more of oxygen (O₂), ozone (O₃), water (H₂O), and hydrogen peroxide (H₂O₂) and one or more inert gases.

In one aspect, the contacting of the one or more carbonaceous materials with the activated mixture may include heating the one or more carbonaceous materials and the activated mixture in the presence of one or more hydrocarbons to a temperature greater than or equal to about 400° C. to less than or equal to about 1400° C. for a time greater than or equal to about 5 minutes to less than or equal to about 12 hours.

In one aspect, the one or more hydrocarbons may be selected from the group consisting of: methane (CH₄), ethane (C₂H₆), propane (C₃H₈), butane (C₄H₁₀), pentane (C₅H₁₂), hexane (C₆H₁₄), heptane (C₇H₁₆), acetylene (C₂H₂), octane (C₈H₁₈), toluene (C₇H₈), natural gas, and combinations thereof.

In one aspect, the contacting of the one or more carbonaceous materials with the activated mixture includes heating the one or more carbonaceous materials and the activated mixture further in the presence one or more gaseous additives selected from the group consisting of: ammonia (NH₃), hydrogen (H₂), carbon monoxide (CO), and combinations thereof.

In one aspect, the one or more electroactive materials may be selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof. The carbonaceous structure may include the one or more carbonaceous material. The one or more carbonaceous materials may be selected from the group consisting of: amorphous carbon, carbon nanotubes (CNTs), carbon nanofibers (CNFs), graphene, graphite, and combinations thereof.

In one aspect, the contacting of the one or more carbonaceous materials with the activated mixture may include heating the one or more carbonaceous materials and the activated mixture in the presence of one or more hydrocarbons to a temperature greater than or equal to about 400° C. to less than or equal to about 1400° C. for a time greater than or equal to about 5 minutes to less than or equal to about 12 hours. The electrode material may include one or more carbon-coated electroactive particles disposed within the carbonaceous structure.

In one aspect, each of the carbon-coated electroactive particles includes an electroactive particle including the one or more electroactive materials and a carbon coating disposed on exposed surfaces of the electroactive particle. The one or more electroactive materials may be selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof. The carbon coating may include one of amorphous and graphitic carbon.

In one aspect, the carbonaceous structure may include the one or more carbonaceous materials. The one or more carbonaceous materials may be selected from the group consisting of: amorphous carbon, carbon nanotubes (CNTs), carbon nanofibers (CNFs), graphene, graphite, and combinations thereof

In one aspect, the carbon coating may have a thickness greater than or equal to about 1 nm to less than or equal to about 200 nm.

In one aspect, the one or more hydrocarbons may be selected from the group consisting of: methane (CH₄), ethane (C₂H₆), propane (C₃H₈), butane (C₄H₁₀), pentane (C₅H₁₂), hexane (C₆H₁₄), heptane (C₇H₁₆), acetylene (C₂H₂), octane (C₈H₁₈), toluene (C₇H₈), natural gas, and combinations thereof. The contacting of the one or more carbonaceous materials with the activated mixture occurs in the presence of one or more gaseous additives selected from the group consisting of: ammonia (NH₃), hydrogen (H₂), carbon monoxide (CO), and combinations thereof.

In one aspect, the method may further include removing the activated catalyst after contacting the precursor with the one or more electroactive materials to form the mixture.

In various other aspects, the present disclosure provides a method of forming an electrode material for use in an electrochemical cell that cycles lithium ions. The method includes contacting a catalyst precursor with one or more electroactive material particles to form a mixture. The catalyst precursor includes one or more metal salts. The one or more metal salts includes one or more metal nitrates M(NO₃)ₓ, metal chlorates MClₓ, metal acetates M(Ac)ₓ, and metal sulfates M₂(SO₄)ₓ, where 1≤x≤5 and M is selected from the group consisting of: nickel (Ni), cobalt (Co), manganese (Mn), iron (Fe), zinc (Zn), vanadium (V), chromium (Cr), molybdenum (Mo), copper (Cu), magnesium (Mg), strontium (Sr), barium (Ba), lanthanum (La), cerium (Ce), and combinations thereof. The one or more electroactive material particles may be selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof. The method may further include activating the catalyst precursor to form an activated catalyst. The activated catalyst may include M. The activated catalyst may be disposed on or adjacent to one or more exposed surfaces of the one or more electroactive material particles. The method may further include contacting one or more carbonaceous materials with the mixture to form a plurality of carbon-coated electroactive particles and a carbonaceous structure; and removing the activated catalyst by etching to form the electrode material. The electrode material includes the plurality of carbon-coated electroactive particles disposed within the carbonaceous structure.

In one aspect, activating may include heating the mixture to a temperature greater than or equal to about 200° C. to less than or equal to about 600° C. for a time greater than or equal to about 5 minutes to less than or equal to about 2 hours.

In one aspect, the contacting of the one or more carbonaceous materials with the mixture may include heating the one or more carbonaceous materials and the mixture in the presence of one or more hydrocarbons to a temperature greater than or equal to about 400° C. to less than or equal to about 1400° C. for a time greater than or equal to about 5 minutes to less than or equal to about 12 hours.

In one aspect, the one or more hydrocarbons may be selected from the group consisting of: methane (CH₄), ethane (C₂H₆), propane (C₃H₈), butane (C₄H₁₀), pentane (C₅H₁₂), hexane (C₆H₁₄), heptane (C₇H₁₆), acetylene (C₂H₂), octane (C₈H₁₈), toluene (C₇H₈), natural gas, and combinations thereof. The contacting of the one or more carbonaceous materials with the activated mixture occurs in the presence of one or more gaseous additives selected from the group consisting of: ammonia (NH₃), hydrogen (H₂), carbon monoxide (CO), and combinations thereof.

In one aspect, each of the plurality of carbon-coated electroactive particles may include the one or more electroactive material particles and a carbon coating disposed on exposed surfaces of each of the one or more electroactive material particles. The carbon coating may include one of amorphous and graphitic carbon and may have a thickness greater than or equal to about 1 nm to less than or equal to about 200 nm. The carbonaceous structure may include one or more carbonaceous materials. The one or more carbonaceous material may be selected from the group consisting of: amorphous carbon, carbon nanotubes (CNTs), carbon nanofibers (CNFs), graphene, graphite, and combinations thereof.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an example electrochemical battery cell;

FIG. 2A is a schematic of an example negative electrode material;

FIG. 2B is an scanning electron microscope (SEM) image of the example negative electrode material of FIG. 2A; and

FIG. 3 is a schematic of another example negative electrode material.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to silicon-carbon composite electrode materials for use in, for example, negative electrodes of lithium-ion electrochemical cells and devices, and methods of formation relating thereto. For example, the silicon-carbon composite may comprise a carbon-coated silicon particle disposed, in certain aspects, within a carbonaceous framework. Methods of forming the silicon-carbon composite electrode material may include, in various aspects, mixing a catalyst precursor with silicon particles, pretreating the mixture for catalytic reaction, disposing the carbon coating and/or framework on or around the silicon particles, and removing the metallic catalytic particles. Such composite electrode materials and electrochemical cells and devices may be used in, for example automotive or other vehicles (e.g., motorcycles, boats). The silicon-carbon composite electrode materials and electrochemical cells and devices may also be used in electrochemical cells in a variety of other industries and applications, such as consumer electronic devices, by way of non-limiting example.

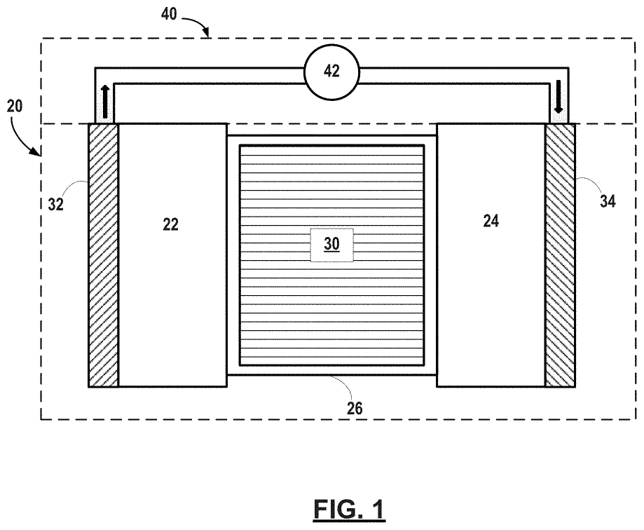

An exemplary and schematic illustration of an electrochemical cell 20 (also referred to herein as “the battery”), that cycles lithium ions is shown in FIG. 1. The battery 20 includes a negative electrode 22, a positive electrode 24, and a separator 26 disposed between the electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte. For example, the separator 26 may be defined by a plurality of solid-state electrolyte particles (not shown).

A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40. For example, an interruptible external circuit 40 and load device 42 connects the negative electrode 22 (through the negative electrode current collector 32) and the positive electrode 24 (through the positive electrode current collector 34). The positive electrode current collector 34 may be a metal foil, metal grid or screen, or expanded metal comprising aluminum or any other appropriate electrically conductive material known to those of skill in the art. The negative electrode current collector 32 may be a metal foil, metal grid or screen, or expanded metal comprising copper or any other appropriate electrically conductive material known to those of skill in the art.

The battery 20 may generate an electric current during discharge by way of reversible electrochemical reactions that occur when the external circuit 40 is closed (to connect the negative electrode 22 and the positive electrode 24) and the negative electrode 22 contains a relatively greater quantity of lithium than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions, which are also produced at the negative electrode 22, are concurrently transferred through the electrolyte 30 contained in the separator 26 towards the positive electrode 24. The electrons flow through the external circuit 40 and the lithium ions migrate across the separator 26 containing the electrolyte solution 30 to form intercalated lithium at the positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the negative electrode 22 so that electrons and lithium ions are produced. The electrons, which flow back towards the positive electrode 24 through the external circuit 40, and the lithium ions, which are carried by the electrolyte solution 30 across the separator 26 back towards the positive electrode 24, reunite at the positive electrode 24 and replenish it with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, the separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that while not depicted here are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 described above includes a liquid electrolyte and shows representative concepts of battery operation. However, the battery 20 may also be a solid state battery that includes a solid state electrolyte that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30, for example inside their pores, capable of conducting lithium ions between the negative electrode 22 and the positive electrode 24. Any appropriate electrolyte 30, whether in solid, liquid, or gel form, capable of conducting lithium ions between the electrodes 22, 24, may be used in the battery 20. For example, the electrolyte 30 may be a non-aqueous liquid electrolyte solution that includes a lithium salt dissolved in an organic solvent or a mixture of organic solvents. Numerous conventional non-aqueous liquid electrolyte solutions may be employed in the battery 20.

Appropriate lithium salts generally have inert anions. A non-limiting list of lithium salts that may be dissolved in an organic solvent or a mixture of organic solvents to form the non-aqueous liquid electrolyte solution include lithium hexafluorophosphate (LiPF₆); lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium difluorooxalatoborate (LiBF₂(C₂O₄)) (LiODFB), lithium tetraphenylborate (LiB(C₆H₅)₄), lithium bis-(oxalate)borate (LiB (C₂O₄)₂) (LiBOB), lithium tetrafluorooxalatophosphate (LiPF₄(C₂O₄)) (LiFOP), lithium nitrate (LiNO₃), lithium hexafluoroarsenate (LiAsF₆), lithium trifluoromethanesulfonate (LiCF₃SO₃), lithium bis(trifluoromethanesulfonimide) (LiTFSI) (LiN(CF₃SO₂)₂), lithium fluorosulfonylimide (LiN(FSO₂)₂) (LiFSI), and combinations thereof. In certain variations, the lithium salt is selected from lithium hexafluorophosphate (LiPF₆), lithium bis(trifluoromethanesulfonimide) (Li TF (LiN(CF₃SO₂)₂), lithium fluorosulfonylimide (LiN(FSO₂)₂) (LiFSI), lithium fluoroalkylphosphate (LiFAP) (Li₃O₄P), and combinations thereof.

These and other similar lithium salts may be dissolved in a variety of organic solvents, including but not limited to various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethyl methyl carbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane (DME), 1-2-diethoxyethane, ethoxymethoxyethane), cyclic ethers (e.g., tetrahydrofuran, 2-methyltetrahydrofuran, 1,3-dioxolane (DOL)), sulfur compounds (e.g., sulfolane), and combinations thereof. In various aspects, the electrolyte 30 may include greater than or equal to 1M to less than or equal to about 2M concentration of the one or more lithium salts. In certain variations, for example when the electrolyte has a lithium concentration greater than about 2 M or ionic liquids, the electrolyte 30 may include one or more diluters, such as fluoroethylene carbonate (FEC) and/or hydrofluoroether (HFE).

The separator 26 may include, in certain instances, a microporous polymeric separator including, for example a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP, or multi-layered structured porous films of PE and/or PP. Commercially available polyolefin porous membranes include CELGARD® 2500 (a monolayer polypropylene separator) and CELGARD® 2320 (a trilayer polypropylene/polyethylene/polypropylene separator) available from Celgard LLC. Various other conventionally available polymers and commercial products for forming the separator 26 are contemplated, as well as the many manufacturing methods that may be employed to produce such a microporous polymer separator 26.

When the separator 26 is a microporous polymeric separator, it may be a single layer or a multi-layer laminate, which may be fabricated from either a dry or wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26.

The separator 26 may also comprise other polymers in addition to the polyolefin such as, but not limited to, polyethylene terephthalate (PET), polyvinylidene fluoride (PVdF), polyamide (nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethyl enenaphthenate, polybutene, polymethylpentene, polyolefin copolymers, acryl onitrile-butadiene styrene copolymers (AB S), polystyrene copolymers, polymethylmethacrylate (PMMA), polysiloxane polymers (e.g., polydimethylsiloxane (PDMS)), polybenzimidazole (PBI), polybenzoxazole (PB 0), polyphenylenes, polyarylene ether ketones, polyperfluorocyclobutanes, polyvinylidene fluoride copolymers (e.g., PVdF—hexafluoropropylene or (PVdF-HFP)), and polyvinylidene fluoride terpolymers, polyvinylfluoride, liquid crystalline polymers (e.g., VECTRAN™ (Hoechst AG, Germany) and ZENITE® (DuPont, Wilmington, Del.)), polyaramides, polyphenylene oxide, cellulosic materials, meso-porous silica, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), titania (TiO₂), and combinations thereof. The heat-resistant material may be selected from the group consisting of: Nomex, Aramid, and combinations thereof.

The positive electrode 24 comprises a lithium-based positive electroactive material that is capable of undergoing lithium intercalation and deintercalation, alloying and dealloying, or plating and stripping, while functioning as a positive terminal of the capacitor battery 20. In various aspects, the positive electrode 24 may be defined by a plurality of electroactive material particles (not shown). Such positive electroactive material particles may be disposed in one or more layers so as to define the three-dimensional structure of the positive electrode 24. In certain variations, as noted above, the positive electrode 24 may further include the electrolyte 30, for example a plurality of electrolyte particles (not shown).

In various aspects, the positive electrode 24 may be one of a layered-oxide cathode, a spinel cathode, and a polyanion cathode. For example, layered-oxide cathodes (e.g., rock salt layered oxides) comprise one or more lithium-based positive electroactive materials selected from LiNiₓMn_{y}Co_{1-x-y}O₂ (where 0≤x≤1 and 0≤y≤1), LiNiₓMn₁₋ₓO₂ (where 0≤x≤1), Lii₊xM02 (where M is one of Mn, Ni, Co, and Al and 0≤x≤1) (for example LiCoO₂ (LCO), LiNiO₂, LiMnO₂, LiNi_{0.5}Mn_{0.5}O₂, NMC111, NMC523, NMC622, NMC721, NMC811, NCA). Spinel cathodes comprise one or more lithium-based positive electroactive materials selected from LiMn₂O₄ (LMO) and LiNi_{0.5}Mn_{1.5}O₄. Olivine type cathodes comprise one or more lithium-based positive electroactive material such as LiV₂(PO₄)₃, LiFePO₄, LiCoPO₄, and LiMnPO₄. Tavorite type cathodes comprise, for example, LiVPO₄F. Borate type cathodes comprise, for example, one or more of LiFeBO₃, LiCoBO₃, and LiMnBO₃. Silicate type cathodes comprise, for example, Li₂FeSiO₄, Li₂MnSiO₄, and LiMnSiO₄F. In still further variations, the positive electrode 24 may comprise one or more other positive electroactive materials, such as one or more of dilithium (2,5-dilithiooxy)terephthalate and polyimide. In various aspects, the positive electroactive material may be optionally coated (for example by LiNbO₃ and/or Al₂O₃) and/or may be doped (for example by one or more of magnesium (Mg), aluminum (Al), and manganese (Mn)).

The positive electroactive material in the positive electrode 24 may be optionally intermingled with one or more electrically conductive materials that provide an electron conductive path and/or at least one polymeric binder material that improves the structural integrity of the positive electrode 24. For example, the positive electroactive material in the positive electrode 24 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

The positive electrode 24 may include greater than or equal to about 50 wt. % to less than or equal to about 99 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 2 wt. % to less than or equal to about 5 wt. %, of one or more electrically conductive materials; and greater than or equal to about 0 wt. % to less than or equal to about 20 wt. %, and in certain aspects, optionally greater than or equal to about 2 wt. % to less than or equal to about 5 wt. %, of one or more binders.

The negative electrode 22 is formed from a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. In certain variations, as noted above, the negative electrode 22 may further include the electrolyte 30, for example a plurality of electrolyte particles (not shown).

In various aspects, the negative electroactive material in the negative electrode 22 may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), lithium polyacrylate (LiPAA), sodium polyacrylate (NaPAA), sodium alginate, lithium alginate, and combinations thereof. Electrically conductive materials may include carbon-based materials, powder nickel or other metal particles, or a conductive polymer. Carbon-based materials may include, for example, particles of carbon black, graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

The negative electrode 22 may include greater than or equal to about 50 wt. % to less than or equal to about 99 wt. %, and in certain aspects, optionally greater than or equal to about 50 wt. % to less than or equal to about 95 wt. %, of the negative electroactive material (e.g., lithium particles or a lithium foil); greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. % of one or more binders.

In various aspects, the present disclosure provides a negative electrode 22 incorporating improved electrochemically active negative electrode materials comprising, for example one or more electroactive materials with high theoretical charge capacities, such as silicon, silicon-containing alloys, tin-containing alloys, germanium-containing alloys, phosphorus-containing alloys, arsenic-containing alloys, bismuth-containing alloys, antimony-containing alloys, and combinations thereof. By way of example, the negative electrode materials may include particles comprising silicon, silicon containing binary and ternary alloys, and/or tin-containing alloys, such as Si—Sn, SiSnFe, SiSnAl, SiFeCo, SnO₂, and the like. As noted above, such negative electroactive materials may, in certain aspects, suffer from significant volumetric expansion during lithium cycling (e.g., capable of accepting the insertion of lithium ions during charging of the electrochemical cell via lithiation or “intercalation” and releasing lithium ions during discharging of the electrochemical cell via delithiation or “deintercalation” or lithium alloying/dealloying). Volumetric expansion that occurs can cause the silicon and/or tin particles to mechanically degrade and break into a plurality of smaller fragments or pieces. When the particle breaks into smaller pieces, these fragments or smaller pieces can no longer maintain performance of the electrochemical cell.

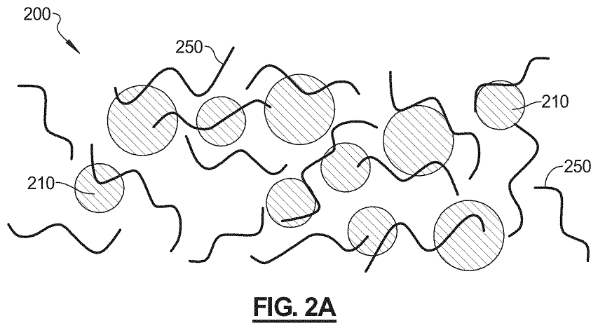

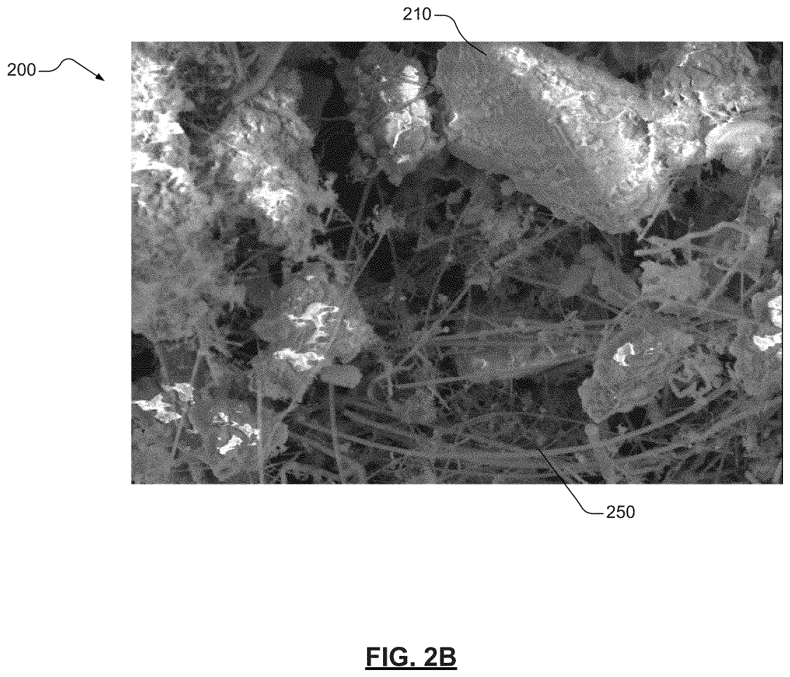

In accordance with various aspects of the present disclosure, the negative electrode material may further include particles having a carbonaceous coating and, in certain aspects, particles disposed within a carbonaceous framework. For example, as illustrated in FIG. 2A, the negative electrode material 200 may comprise a plurality of electroactive particles 210 that are disposed or embedded within a carbonaceous structure 250. The electroactive particles 210 may have an average particle diameter that is greater than or equal to about 50 nm to less than or equal to about 10 μm and may include one or more electroactive materials selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof. The carbonaceous structure 250 may comprise one or more carbon materials selected from the group consisting of: amorphous carbon, carbon nanotubes (CNTs), carbon nanofibers (CNFs), graphene, graphite, and combinations thereof. As best seen in FIG. 2B, the carbonaceous structure 250 may interconnect the electroactive particles 210.

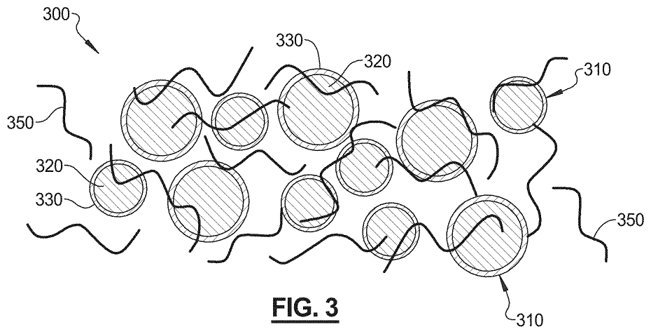

As illustrated in FIG. 3, the negative electrode material 300 may, in various other aspects, comprise a plurality of carbon-coated electroactive particles 310. The carbon-coated electroactive particles 310 may each comprise an electroactive material particle 320 comprising, for example, silicon, silicon-containing alloys, tin-containing alloys, and combinations thereof, and a carbon coating 330 disposed on the exposed surfaces of the electroactive material particle 320. The electroactive material particles 320 may have an average particle diameter that is greater than or equal to about 50 nm to less than or equal to about 10 pm. The carbon coating 330 may comprise one or more carbonaceous materials such as, for example, amorphous or graphitic carbon. The carbon coating 330 may have a thickness greater than or equal to about 1 nm to less than or equal to about 400 nm, optionally greater than or equal to about 1 nm to less than or equal to about 200 nm, and in certain aspects, optionally greater than or equal to about 20 nm to less than or equal to about 100 nm. The skilled artisan will recognize that though not shown, that in certain instances, the carbon coating 330 may comprise a plurality of stacked layers disposed on or near the exposed surfaces of the electroactive material particle 320. The carbon coating 330 may, in various aspects, protect the electroactive material particle 320 from cracking, particularly during volumetric changes.

As illustrated, in certain aspects, the carbon-coated electroactive particles 310 may be disposed or embedded within a carbonaceous structure 350. Like the carbonaceous structure 250 illustrated in FIGS. 2A and 2B, the carbonaceous structure 350 illustrated in FIG. 3 may also comprise one or more carbon materials selected from the group consisting of: amorphous carbon, carbon nanotubes (CNTs), carbon nanofibers (CNFs), graphene, graphite, and combinations thereof. The carbon coating 330 may, in certain aspects, help disperse the carbon-coated electroactive particles 310 within or among the carbonaceous structure 350.

In various aspects, the present disclosure provides a method of making an electrode material comprising one or more electroactive particles disposed within a carbonaceous structure, for example the negative electrode material 200 illustrated in FIGS. 2A and 2B and/or the negative electrode material 300 illustrated in FIG. 3. The method includes contacting a catalyst precursor comprising one or more metal salts with one or more electroactive materials, for example electroactive material particles, to form a mixture; pretreating the mixture to activate the catalyst precursor; and contacting one or more carbonaceous materials with the activated mixture to form the electrode material.

In various aspects, contacting of the one or more metal salts with the one or more electroactive materials occurs using a process selected from impregnation, ball milling, physical vapor deposition (PVD), chemical vapor deposition (CVD), plasma-enhanced chemical vapor deposition (PECVD), atomic layer deposition (ALD), molecular layer deposition (MLD), spin coating, and spray drying. In such manners, the one or more metal salts are disposed on or adjacent to one or more surfaces of the one or more electroactive material particles. For example, the one or more metal salts may be dispersed over one or more exposed surface of one or more electroactive material particles such that the metal salts cover greater than or equal to about 10% to less than or equal to 100% of the total surface area of each electroactive material particle. For example, in various aspects the mixture includes greater than or equal to about 0.1 wt. % to less than or equal to about 20 wt. %, and in certain aspects, optionally greater than or equal to about 1 wt. % to less than or equal to about 15 wt. %, of the one or more metal salts; and greater than or equal to about 80 wt. % to less than or equal to about 99.9 wt. %, and in certain aspects, optionally greater than or equal to about 85 wt. % to less than or equal to about 99 wt. %, of the one or more electroactive materials.

In certain variations, the one or more metal salts, for example metal hydroxides, may comprise one or more metal nitrates M(NO₃)ₓ, metal chlorates MClₓ, metal acetates M(Ac)ₓ, or metal sulfates M₂(SO₄)ₓ, where 1≤x≤5 and M is one of a transition metal, such as nickel (Ni), cobalt (Co), manganese (Mn), iron (Fe), zinc (Zn), vanadium (V), chromium (Cr), molybdenum (Mo), an/or copper (Cu); an alkaline earth metal, such as magnesium (Mg), strontium (Sr), and/or barium (Ba); a rare earth metal, such as lanthanum (La) and/or cerium (Ce); and combinations thereof. The one or more electroactive materials may be selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof.

In various aspects, pretreating the mixture so as to activate the catalyst precursor includes inert calcination. For example, the mixture may be heated to a temperature greater than or equal to about 200° C. to less than or equal to about 600° C., and in certain aspects, optionally greater than or equal to about 300° C. to less than or equal to about 500° C. The mixture may be heated for a time greater than or equal to about 5 minutes to less than or equal to about 2 hours, and in certain aspects, optionally greater than or equal to about 15 minutes to less than or equal to about 1 hour. In certain variations, calcination occurs in an environment comprising one or more reductants, such as hydrogen (H₂). For example, the calcination environment may comprise greater than or equal to about 0 wt. % to less than or equal to about 20 wt. % of hydrogen (H₂). In other variations, calcination occurs in an environment comprising one or more oxidants, such as one or more of oxygen (O₂), ozone (O₃), water (H₂O), hydrogen peroxide (H₂O₂), and one or more other inert gases. For example, the calcination environment may comprise greater than or equal to about 0 wt. % to less than or equal to about 100 wt. %, and in certain aspects, greater than or equal to about 5 wt. % to less than or equal to about 20 wt. %, of the one or more oxidants. In each instance, the one or more metal salts are activated such that one or more metallic particles alone are disposed on or adjacent to one or more surfaces of the one or more electroactive material particles. The particle size of the catalytic metallic particles may be greater than or equal to 1 nm to less than or equal to 500 nm, and in certain aspects, greater than or equal to about 5 nm to less than or equal to about 50 nm. The metallic particles are dispersed over greater than or equal to about 10% to less than or equal to about 100% of the total surface area of each electroactive material particle.

In various aspects, contacting the one or more carbonaceous materials with the activated mixture to form the carbon-coated electroactive particles includes disposing or embedding the one or more electroactive material particles, including the one or more metallic particles, in a carbonaceous structure. For example, contacting the one or more carbonaceous materials with the activated mixture may involve gas phase pyrolysis, for example heating the one or more carbonaceous materials and the activated mixture in the presence of one or more gaseous hydrocarbons to a temperature greater than or equal to about 400° C. to less than or equal to about 1400° C., and in certain aspects, greater than or equal to about 600° C. to less than or equal to about 1000° C. In certain variations, the environment may comprise greater than or equal to about 10 wt. %, and in certain aspects, optionally greater than or equal to about 20 wt. %, of the one or more gaseous hydrocarbons. The one or more hydrocarbons may be selected from the group consisting of: methane (CH₄), ethane (C₂H₆), propane (C₃H₈), butane (C₄H₁₀), pentane (C₅H₁₂), hexane (C₆H₁₄), heptane (C₇H1₆), acetylene (C₂H₂), octane (C₈H₁₈), toluene (C₇H₈), natural gas, and combinations thereof. In further variations, the environment may further include one or more additional additives, such as, for example, ammonia (NH₃), hydrogen (H₂), and/or carbon monoxide (CO). In certain variations, the environment may comprise greater than or equal to about 1 wt. % to less than or equal to about 30 wt. %, and in certain aspects, optionally greater than or equal to about 10 wt. % to less than or equal to about 20 wt. %, of the one or more gaseous hydrocarbons. In certain aspects, the one or more carbonaceous materials and the activated mixture may be heated for a time greater than or equal to about 5 minutes to less than or equal to about 12 hours, and in certain aspects, optionally greater than or equal to about 1 hour to less than or equal to about 6 hours.

The heating temperature and duration, as well as the hydrocarbon concentration and flow rates in the heating environment, during gas phase pyrolysis may affect the morphology of the electrode material. For example, in instances of higher temperatures and long durations, for example temperatures greater than or equal to about 800° C. to less than or equal to about 1400° C., and in certain aspects, optionally greater than or equal to about 900° C. to less than or equal to about 1100° C. and heating times greater than or equal to about 2 hours to less than or equal to about 12 hours, and in certain aspects, optionally greater than or equal to about 4 hours to less than or equal to about 6 hours, the formed electrode material may comprise one or more carbon-coated electroactive particles disposed within the carbonaceous structure—such as amorphous carbon and graphic carbon coating layers on the surfaces of the electroactive particles, as well as carbon nanotubes (CNTs) frameworks interconnected among the electroactive particles, for example the negative electrode material 300 illustrated in FIG. 3. In instances of lower temperatures and shorter durations, for example temperatures greater than or equal to about 400° C. to less than or equal to about 900° C., and in certain aspects, optionally greater than or equal to about 500° C. to less than or equal to about 800° C. and heating times greater than or equal to about 1 hour to less than or equal to about 6 hours, and in certain aspects, optionally greater than or equal to about 2 hours to less than or equal to about 4 hours, the formed electrode material may comprise the one or more electroactive particles disposed within the carbonaceous structure, such as the carbon nanotubes (CNTs) frameworks interconnected among the electroactive particles, for example as illustrated in FIGS. 2A and 2B.

In each instance, once the one or more electroactive material particles, including the one or more metallic particles, are disposed or embedded within a carbonaceous structure, the one or more metallic particles may be removed so as to prevent possible detrimental side reactions in the battery environment. The one or more metallic particles may be removed using one of acid and base etching. For example, the one or more electroactive material particles, including the one or more metallic particles, disposed or embedded within a carbonaceous structure, may be contacted with an acid or base solution having a predetermined concentration for a predetermined period of time, and in certain instances washed with, for example distilled water, and dried. In various aspects, one or more of nitric acid (HNO₃), hydrogen chloride (HCl), sulfuric acid (H₂SO₄), sodium hydroxide (NaOH), and potassium hydroxide (KOH) may be used. In certain aspects, the concentration of the acid or base may be greater than or equal to about 0.01 mol/L to less than or equal to about 10 mol/L. The one or more electroactive material particles, including the one or more metallic particles, disposed or embedded within a carbonaceous structure, may be contacted with the acid or base solution for a time greater than or equal to about 10 minutes to less than or equal to about 48 hours.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of forming an electrode material for use in an electrochemical cell that cycles lithium ions, the method comprising:
contacting a catalyst precursor comprising one or more metal salts with one or more electroactive materials that undergo volumetric expansion to form a mixture;
activating the catalyst precursor in the mixture to form an activated mixture comprising an activated catalyst; and
contacting one or more carbonaceous materials with the activated mixture to form the electrode material that comprises one or more electroactive particles comprising the one or more electroactive materials disposed within a carbonaceous structure comprising the one or more carbonaceous materials selected from the group consisting of: amorphous carbon, carbon nanotubes (CNTs), carbon nanofibers (CNFs), graphene, graphite, and combinations thereof.

2. The method of claim 1, wherein the one or more metal salts comprise one or more metal nitrates M(NO₃)ₓ, metal chlorates MClₓ, metal acetates M(Ac)ₓ, and metal sulfates M₂(SO₄)ₓ, where 1≤x≤5 and M is selected from the group consisting of: nickel (Ni), cobalt (Co), manganese (Mn), iron (Fe), zinc (Zn), vanadium (V), chromium (Cr), molybdenum (Mo), copper (Cu), magnesium (Mg), strontium (Sr), barium (Ba), lanthanum (La), cerium (Ce), and combinations thereof.

3. The method of claim 1, wherein the activating includes heating the mixture to a temperature greater than or equal to about 200° C. to less than or equal to about 600° C. for a time greater than or equal to about 5 minutes to less than or equal to about 2 hours.

4. The method of claim 3, wherein the mixture is heated in an environment further comprising greater than about 0% to less than or equal to about 20% of hydrogen (H₂).

5. The method of claim 3, wherein the mixture is heated in an environment further comprising one or more of oxygen (O₂), ozone (O₃), water (H₂O), and hydrogen peroxide (H₂O₂) and one or more inert gases.

6. The method of claim 1, wherein the contacting of the one or more carbonaceous materials with the activated mixture includes heating the one or more carbonaceous materials and the activated mixture in the presence of one or more hydrocarbons to a temperature greater than or equal to about 400° C. to less than or equal to about 1400° C. for a time greater than or equal to about 5 minutes to less than or equal to about 12 hours.

7. The method of claim 6, wherein the one or more hydrocarbons are selected from the group consisting of: methane (CH₄), ethane (C₂H₆), propane (C₃H₈), butane (C₄H₁₀), pentane (C₅H₁₂), hexane (C₆H₁₄), heptane (C₇H1₆), acetylene (C₂H₂), octane (C₈H₁₈), toluene (C₇H₈), natural gas, and combinations thereof.

8. The method of claim 7, wherein the contacting of the one or more carbonaceous materials with the activated mixture includes heating the one or more carbonaceous materials and the activated mixture further in the presence one or more gaseous additives selected from the group consisting of: ammonia (NH₃), hydrogen (H₂), carbon monoxide (CO), and combinations thereof.

9. The method of claim 6, wherein the one or more electroactive materials are selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof;

10. The method of claim 1, wherein the contacting of the one or more carbonaceous materials with the activated mixture includes heating the one or more carbonaceous materials and the activated mixture in the presence of one or more hydrocarbons to a temperature greater than or equal to about 400° C. to less than or equal to about 1400° C. for a time greater than or equal to about 5 minutes to less than or equal to about 12 hours and the one or more electroactive particles are electrode material comprises one or more carbon-coated electroactive particles disposed within the carbonaceous structure, wherein each of the one or more carbon-coated electroactive particles comprises an electroactive particle core comprising the one or more electroactive materials and a continuous carbon coating disposed on exposed surfaces of the electroactive particle.

11. The method of claim 10, wherein the one or more electroactive materials are selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof and the carbon coating comprises one of amorphous and graphitic carbon.

12. (canceled)

13. The method of claim 11, wherein the carbon coating has a thickness greater than or equal to about 1 nm to less than or equal to about 200 nm.

14. The method of claim 10, wherein the one or more hydrocarbons are selected from the group consisting of: methane (CH₄), ethane (C₂H₆), propane (C₃H₈), butane (C₄H₁₀), pentane (C₅H₁₂), hexane (C₆H₁₄), heptane (C₇H1₆), acetylene (C₂H₂), octane (C₈H₁₈), toluene (C₇H₈), natural gas, and combinations thereof, and
wherein the contacting of the one or more carbonaceous materials with the activated mixture occurs in the presence of one or more gaseous additives selected from the group consisting of: ammonia (NH₃), hydrogen (H₂), carbon monoxide (CO), and combinations thereof.

15. The method of claim 1, wherein the method further includes removing the activated catalyst after the contacting.

16. A method of forming an electrode material for use in an electrochemical cell that cycles lithium ions, the method comprising:
contacting a catalyst precursor comprising one or more metal nitrates M(NO₃)ₓ, metal chlorates MClₓ, metal acetates M(Ac)ₓ, and metal sulfates M₂(SO₄)ₓ, where 1≤x≤5 and M is selected from the group consisting of: nickel (Ni), cobalt (Co), manganese (Mn), iron (Fe), zinc (Zn), vanadium (V), chromium (Cr), molybdenum (Mo), copper (Cu), magnesium (Mg), strontium (Sr), barium (Ba), lanthanum (La), cerium (Ce), and combinations thereof with one or more electroactive material particles selected from the group consisting of: silicon, silicon-containing alloys, tin-containing alloys, germanium-containing alloys, phosphorus-containing alloys, arsenic-containing alloys, bismuth-containing alloys, antimony-containing alloys, and combinations thereof to form a mixture;
activating the catalyst precursor to form an activated catalyst comprising M, where the activated catalyst is disposed on or adjacent to one or more exposed surfaces of the one or more electroactive material particles;
contacting one or more carbonaceous materials with the mixture to form a plurality of carbon-coated electroactive particles and a carbonaceous structure that comprises the one or more carbonaceous materials selected from the group consisting of: amorphous carbon, carbon nanotubes (CNTs), carbon nanofibers (CNFs), graphene, graphite, and combinations thereof, and wherein each of the one or more carbon-coated electroactive particles comprises an electroactive particle core comprising the one or more electroactive materials and a continuous carbon coating disposed on exposed surfaces of the electroactive particle; and
removing the activated catalyst by etching to form the electrode material comprising the plurality of carbon-coated electroactive particles disposed within the carbonaceous structure.

17. The method of claim 16, wherein the activating includes heating the mixture to a temperature greater than or equal to about 200° C. to less than or equal to about 600° C. for a time greater than or equal to about 5 minutes to less than or equal to about 2 hours.

18. The method of claim 16, wherein the contacting of the one or more carbonaceous materials with the mixture includes heating the one or more carbonaceous materials and the mixture in the presence of one or more hydrocarbons to a temperature greater than or equal to about 400° C. to less than or equal to about 1400° C. for a time greater than or equal to about 5 minutes to less than or equal to about 12 hours.

19. The method of claim 18, wherein the one or more hydrocarbons are selected from the group consisting of: methane (CH₄), ethane (C₂H₆), propane (C₃H₈), butane (C₄H₁₀), pentane (C₅H₁₂), hexane (C₆H₁₄), heptane (C₇H1₆), acetylene (C₂H₂), octane (C₈H₁₈), toluene (C₇H₈), natural gas, and combinations thereof, and
the contacting of the one or more carbonaceous materials with the activated mixture occurs in the presence of one or more gaseous additives selected from the group consisting of: ammonia (NH₃), hydrogen (H₂), carbon monoxide (CO), and combinations thereof.

20. The method of claim 16, wherein the carbon coating comprises one of amorphous and graphitic carbon and has a thickness greater than or equal to about 1 nm to less than or equal to about 200 nm.

21. The method of claim 1, wherein the one or more electroactive particles have an average diameter greater than or equal to about 50 nm to less than or equal to about 10 μm.
